(19) United States
(12) Patent Application Publication
(10) Pub. No.: US 2025/0321816 A1
(43) Pub. Date: Oct. 16, 2025

(54) SYSTEMS AND METHODS FOR DETERMINING NEAR-DEATH STATE OF AN INFORMATION HANDLING SYSTEM

(71) Applicant: Dell Products L.P., Round Rock, TX (US)

(72) Inventors: Ravishankar Kanakapura N, Bangalore (IN); Shrinidhi KATTE, Bangalore (IN); Michael E. BROWN, Austin, TX (US)

(73) Assignee: Dell Products L.P., Round Rock, TX (US)

(21) Appl. No.: 18/635,523

(22) Filed: Apr. 15, 2024

(51) Int. Cl. G06F 11/07

(52) U.S. Cl. CPC G06F 11/0757; G06F 11/0706; G06F 11/0793; G06F 11/0778; G06F 11/079

(57) ABSTRACT

An information handling system may include a processor and a management controller configured to provide out-of-band management facilities for management of the information handling system, the management controller further configured to receive multiple instances of a periodic messaging signal from the processor, determine a jitter in the periodicity of the multiple instances of the periodic messaging signal, and analyze the jitter to determine if a near-death state of the information handling system exists.

### TECHNICAL FIELD

The present disclosure relates in general to information handling systems, and more particularly to systems and methods for inventory collection in a management controller of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems include a management controller, which is an embedded computer system that may control fans, power, and/or other high-level functions of an information handling system. A typical management controller may provide a “watchdog” function, in which a host processor of the information handling system may, once enabled, periodically ping the watchdog function of the management controller to inform the management controller that the host processor remains alive and correctly processing data.

In some instances, a host processor may enter a degraded state in which it barely meets timeouts of the management controller watchdog, and thus does not trigger the failure recovery provided by the management controller. However, in such a degraded state, the information handling system may not meet a user's performance expectations. Sometimes a system may recover from such state, but other times the degraded state (e.g., referred to herein as “near-death state”) may last for a long time before another event causes failure of the host processor to fail to satisfy a watchdog timeout.

One potential problem is that an underlying root cause might cause a near-death state, but an information handling system may take a long time to fail, during which time the original information needed to determine a root cause of the failure may be lost from the information handling system.

### SUMMARY

In accordance with the teachings of the present disclosure, the disadvantages and problems associated with determining a near-death state of an information handling system may be reduced or eliminated.

In accordance with embodiments of the present disclosure, an information handling system may include a processor and a management controller configured to provide out-of-band management facilities for management of the information handling system, the management controller further configured to receive multiple instances of a periodic messaging signal from the processor, determine a jitter in the periodicity of the multiple instances of the periodic messaging signal, and analyze the jitter to determine if a near-death state of the information handling system exists.

In accordance with these and other embodiments of the present disclosure, a method may include receiving multiple instances of a periodic messaging signal from a processor of an information handling system, determining a jitter in the periodicity of the multiple instances of the periodic messaging signal, and analyzing the jitter to determine if a near-death state of the information handling system exists.

In accordance with these and other embodiments of the present disclosure, an article of manufacture of include a computer readable medium and computer-executable instructions carried on the computer readable medium, the instructions readable by a processing device, the instructions, when read and executed, for causing the processing device to, in a management controller configured to provide out-of-band management facilities for management of an information handling system: receive multiple instances of a periodic messaging signal from a processor of the information handling system, determine a jitter in the periodicity of the multiple instances of the periodic messaging signal, and analyze the jitter to determine if a near-death state of the information handling system exists. Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of an example method for determining a near-death state of an information handling system, in accordance with embodiments of the present disclosure.

### DETAILED DESCRIPTION

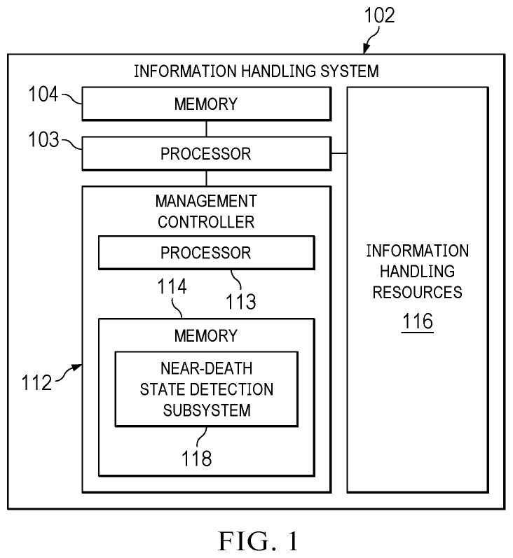

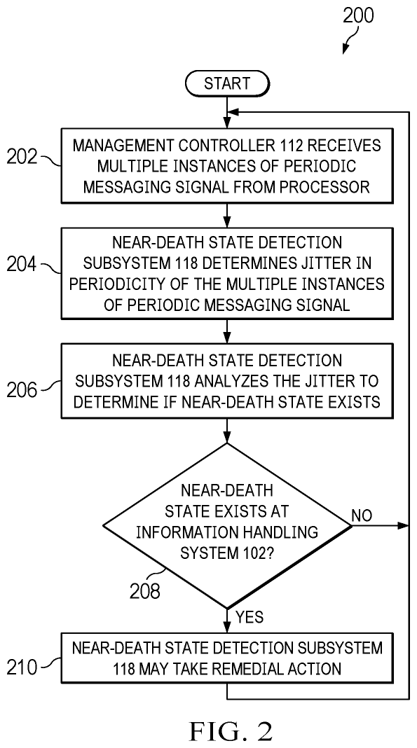

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a server. In other embodiments, information handling system 102 may be a personal computer (e.g., a desktop computer, a laptop, notebook, tablet, handheld, smart phone, personal digital assistant, etc.). As depicted in FIG. 1, information handling system 102 may include a processor 103, a memory 104 communicatively coupled to processor 103, a management controller 112 communicatively coupled to processor 103, and one or more information handling resources 116 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Management controller 112 may be configured to provide out-of-band management facilities for management of information handling system 102. Such management may be made by management controller 112 even if information handling system 102 is powered off or powered to a standby state. Management controller 112 may include a processor 113, memory 114, and an out-of-band network interface separate from and physically isolated from an in-band network interface. In certain embodiments, management controller 112 may include or may be an integral part of a baseboard management controller (BMC), a remote access controller (e.g., a Dell Remote Access Controller or Integrated Dell Remote Access Controller), or an enclosure controller. In other embodiments, management controller 112 may include or may be an integral part of a chassis management controller (CMC).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in computer-readable media of information handling system 102 or management controller 112 (e.g., memory 114). As shown in FIG. 1, processor 113 may be communicatively coupled to processor 103. Such coupling may be via a Universal Serial Bus (USB), System Management Bus (SMBus), general purpose input/output (GPIO) channel and/or one or more other communications channels.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. Memory 114 may have stored thereon software and/or firmware which may be read and executed by processor 113 for carrying out the functionality of management controller 112. As shown in FIG. 1, memory 114 may have stored thereon near-death state detection subsystem 118.

As described in greater detail elsewhere in this disclosure, near-death state detection subsystem 118 may include any system, device, or apparatus configured to, based on timing information associated with a periodic communication of a message from processor 103 to management controller 112, determine if information handling system 102 is in a near-death state. In some embodiments, near-death state detection subsystem 118 may be implemented as a program of instructions that may be read by and executed on processor 103 to carry out the functionality of near-death state detection subsystem 118.

Generally speaking, information handling resources 116 may include any component system, device or apparatus of information handling system 102, including without limitation processors, buses, computer-readable media, input-output devices and/or interfaces, storage resources, network interfaces, motherboards, electro-mechanical devices (e.g., fans), displays, and/or power supplies.

FIG. 2 illustrates a flow chart of an example method 200 for determining a near-death state of information handling system 102, in accordance with embodiments of the present disclosure. According to one embodiment, method 200 may begin at step 202. As noted above, teachings of the present disclosure may be implemented in a variety of configurations of information handling system 102.

At step 202, management controller 112 may receive a multiple instances of a periodic messaging signal from processor 103. The periodic messaging signal may be of any suitable type of periodic signal that may be communicated from processor 103 to management controller 112. For example, and without limitation, the periodic messaging signal may comprise a ping signal associated with a watchdog timer of management controller 112 that may cause the watchdog timer to reset.

At step 204, near-death state detection subsystem 118 may determine a jitter in the periodicity of the multiple instances of the periodic messaging signal. For example, in some embodiments, such jitter may be based on a measure of the durations of time between receipt by management controller 112 of successive instances of the periodic messaging signal. In some embodiments, such jitter may be a function of multiple durations of time between receipt by management controller 112 of successive instances of the periodic messaging signal, in order to smooth or average the jitter measurement to reduce the effects of random outliers on the determination of jitter.

At step 206, near-death state detection subsystem 118 may analyze the jitter to determine if a near-death state exists. In some embodiments, such analysis may be as simple as determining if the jitter exceeds a threshold. In other embodiments, near-death state detection subsystem 118 may apply more complex machine learning and/or linear regression techniques.

At step 208, based on the analysis performed at step 206, near-death state detection subsystem 118 may determine if a near-death state exists at information handling system 102. If a near-death state exists, method 200 may proceed to step 210. Otherwise, method 200 may return to step 202.

At step 210, in response to existence of the near-death state, near-death state detection subsystem 118 may take a remedial action. For example, in some embodiments, such remedial action may include recording the existence of the near-death state in a log of information handling system 102. As another example, in these or other embodiments, such remedial action may include communicating an alert (e.g., visual and/or audio) to a user or administrator of information handling system 102 indicating occurrence of the near-death state. As a further example, in these or other embodiments, such remedial action may include near-death state detection subsystem 118 analyzing diagnostic information present at the time of occurrence of the near-death state in order to determine a cause of the near-death state. After completion of step 210, method 200 may proceed again to step 202. Alternatively, in some embodiments, method 200 may end after completion of step 210.

Although FIG. 2 discloses a particular number of steps to be taken with respect to method 200, method 200 may be executed with greater or lesser steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless Otherwise Specifically Noted, Articles Depicted in the Figures are not Necessarily Drawn to Scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. An information handling system comprising:
a processor; and
a management controller configured to provide out-of-band management facilities for management of the information handling system, the management controller further configured to:
receive multiple instances of a periodic messaging signal from the processor;
determine a jitter in the periodicity of the multiple instances of the periodic messaging signal; and
analyze the jitter to determine if a near-death state of the information handling system exists.

2. The information handling system of claim 1, wherein the management controller is further configured to take a remedial action responsive to existence of the near-death state.

3. The information handling system of claim 2, wherein the remedial action comprises communication of an alert.

4. The information handling system of claim 1, wherein the periodic messaging signal comprises a ping signal associated with a watchdog timer of the management controller.

5. The information handling system of claim 1, wherein the jitter is based on a measure of durations of time between receipt by the management controller of successive instances of the periodic messaging signal.

6. The information handling system of claim 5, wherein the jitter is based on a measure of a difference between two durations of time between receipt by the management controller of successive instances of the periodic messaging signal.

7. A method comprising:
receiving multiple instances of a periodic messaging signal from a processor of an information handling system;
determining a jitter in the periodicity of the multiple instances of the periodic messaging signal; and
analyzing the jitter to determine if a near-death state of the information handling system exists.

8. The method of claim 7, further comprising taking a remedial action responsive to existence of the near-death state.

9. The method of claim 8, wherein the remedial action comprises communication of an alert.

10. The method of claim 7, wherein the periodic messaging signal comprises a ping signal associated with a watchdog timer of the management controller.

11. The method of claim 7, wherein the jitter is based on a measure of durations of time between receipt by the management controller of successive instances of the periodic messaging signal.

12. The method of claim 11, wherein the jitter is based on a measure of a difference between two durations of time between receipt by the management controller of successive instances of the periodic messaging signal.

13. An article of manufacture comprising:
a computer readable medium; and
computer-executable instructions carried on the computer readable medium, the instructions readable by a processing device, the instructions, when read and executed, for causing the processing device to, in a management controller configured to provide out-of-band management facilities for management of an information handling system:
receive multiple instances of a periodic messaging signal from a processor of the information handling system;
determine a jitter in the periodicity of the multiple instances of the periodic messaging signal; and
analyze the jitter to determine if a near-death state of the information handling system exists.

14. The article of claim 13, the instructions for further causing the processing device to take a remedial action responsive to existence of the near-death state.

15. The article of claim 14, wherein the remedial action comprises communication of an alert.

16. The article of claim 13, wherein the periodic messaging signal comprises a ping signal associated with a watchdog timer of the management controller.

17. The article of claim 13, wherein the jitter is based on a measure of durations of time between receipt by the management controller of successive instances of the periodic messaging signal.

18. The article of claim 17, wherein the jitter is based on a measure of a difference between two durations of time between receipt by the management controller of successive instances of the periodic messaging signal.
